(19) United States
(12) Patent Application Publication
(10) Pub. No.: US 2021/0358333 A1
(43) Pub. Date: Nov. 18, 2021

(54) GREETING CARD SYSTEM

(71) Applicant: Jorge E. Delgado, Miami, FL (US)

(72) Inventor: Jorge E. Delgado, Miami, FL (US)

(21) Appl. No.: 15/930,368

(22) Filed: May 12, 2020

(51) Int. Cl. G09F 1/04; B65D 75/14; B65D 75/54

(52) U.S. Cl. CPC G09F 1/04; B65D 75/54; B65D 75/14

(57) ABSTRACT

A greeting card system includes a greeting card having a top panel connected to a spine of a bottom panel, a gift holder area defined on the bottom panel, the top panel including a first surface and a second surface opposite the first surface, the bottom panel including an inside surface and a back surface opposite the inside surface, where opening the top panel reveals the gift holder area of the bottom panel. The greeting card system can further include a frame that surrounds the gift holder area of the bottom panel. The greeting card system can further include a treat positioned in the gift holder area of the bottom panel.

### BACKGROUND OF THE INVENTION

### Field of the Invention

The field of the invention generally relates to greeting card systems, and more particularly to a greeting card system that includes an area configured to receive one or more treats.

### Description of the Related Art

Most conventional greeting cards are an illustrated piece of card stock or high quality paper featuring an expression of friendship or other sentiment. One problem with these conventional greeting cards is they lack the option of including a treat or baked good with the greeting card.

Normally, a consumer sending or gifting to a recipient will separately provide a gift to accompany the greeting card. For example, a consumer may provide a greeting card and flowers. In another example, a consumer may provide a greeting card and a box of chocolates or some other edible sweets. By providing a greeting card system with edible sweets predisposed within the greeting card system, the consumer consolidates the gift and the greeting card into the same package, saving both time, expense and materials involved in a transaction involving separate items.

Additionally, greeting cards include artwork and a pre-printed message previously selected by the greeting card manufacturer. Consumers have limited choice in selecting the artwork and the message included in the greeting card. By providing an e-commerce platform for consumers that allows for customization, the consumer is able to select both the greeting card artwork content (or upload his or her own), as well as include a personalized message as part of the greeting card system.

### BRIEF SUMMARY OF THE INVENTION

Embodiments of the present invention address deficiencies of the art in respect to greeting cards and provides a novel and non-obvious greeting card system adapted for providing various types of greeting cards. In one embodiment of the invention, a greeting card system includes top panel that has a greeting printed on the inside surface of the top panel, the top panel is connected to a spine of a bottom panel of the greeting card system that includes a frame with a gift holder area configured to receive treats (e.g., cookies, chocolate, etc.) where the frame includes a left side, a right side opposite the left side, a front side and a spine opposite the front side of the frame. In another aspect of the embodiment, the frame with a gift holder area of the greeting card system can be configured to receive a tray that includes the treats (e.g., cookies, chocolate, etc.).

In one embodiment, the greeting card system includes a greeting card having a top panel connected to a spine of a bottom panel, a gift holder area defined on the bottom panel, the top panel including a first surface and a second surface opposite the first surface, the bottom panel including an inside surface and a back surface opposite the inside surface, where opening the top panel reveals the gift holder area of the bottom panel.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a perspective view of a portion of a greeting card with gift holder constructed in an open position in accordance with embodiments of the present invention;

FIG. 2 is a top view of a greeting card with gift holder in an open position and assembled in accordance with one embodiment of the present invention;

FIG. 3 is a top view of a greeting card with gift holder in an open position and assembled in accordance with one embodiment of the present invention;

FIG. 4 is a rear view of a greeting card with gift holder in an open position and assembled in accordance with one embodiment of the present invention;

FIG. 5 is a rear perspective view of a tray for insertion into the gift holder of the greeting card of FIG. 3; and

FIG. 6 is a side perspective view of the tray of FIG. 5 of the present invention.

### DETAILED DESCRIPTION OF THE INVENTION

Embodiments of the present invention address deficiencies of the art with respect to conventional greetings cards and provide a novel and non-obvious greeting card system adapted for providing various types of greeting card systems that include an area configured to receive one or more treats. In one embodiment of the invention, a greeting card system includes a top panel coupled to a bottom panel at a spine portion, the bottom panel including a gift holder area configured to receive a gift or treat. The bottom panel of the greeting card system has an outer surface that can be written on to address the greeting card system to an individual. Similarly, the back surface of the top panel can include artwork or graphics. In addition, the front surface of the top panel can include a sentimental message or the like. In one embodiment, the top panel is pre-perforated at the spine to allow a greeting card recipient to separate this section of the greeting that has a higher emotional value from the bottom panel with the gift holder area. In another aspect of the embodiment, the greeting card system, the bottom panel can include a frame portion that surrounds the gift holder area that includes a left side, a right side opposite the left side, and a front side opposite the spine portion. In yet another aspect of the embodiment, the greeting card system can further include a tray for insertion into the gift holder of the greeting card system. The tray can include the treat for easy placement in the frame of the bottom panel of the greeting card system. In another embodiment, the frame may be removed and a tray that is sized to cover the top surface area of the bottom panel can be used to receive the treat. By providing a greeting card system with edible sweets predisposed within the greeting card system, the consumer consolidates the gift and the greeting card into the same package, saving both time, expense and materials involved in a transaction involving separate items. In one embodiment, a greeting card system includes a greeting card having a top panel connected to a spine of a bottom panel, a gift holder area defined on the bottom panel, a frame that surrounds the gift holder area of the bottom panel, the top panel including a first surface and a second surface opposite the first surface, the bottom panel including an inside surface and a back surface opposite the inside surface, where opening the top panel reveals the gift holder area of the bottom panel.

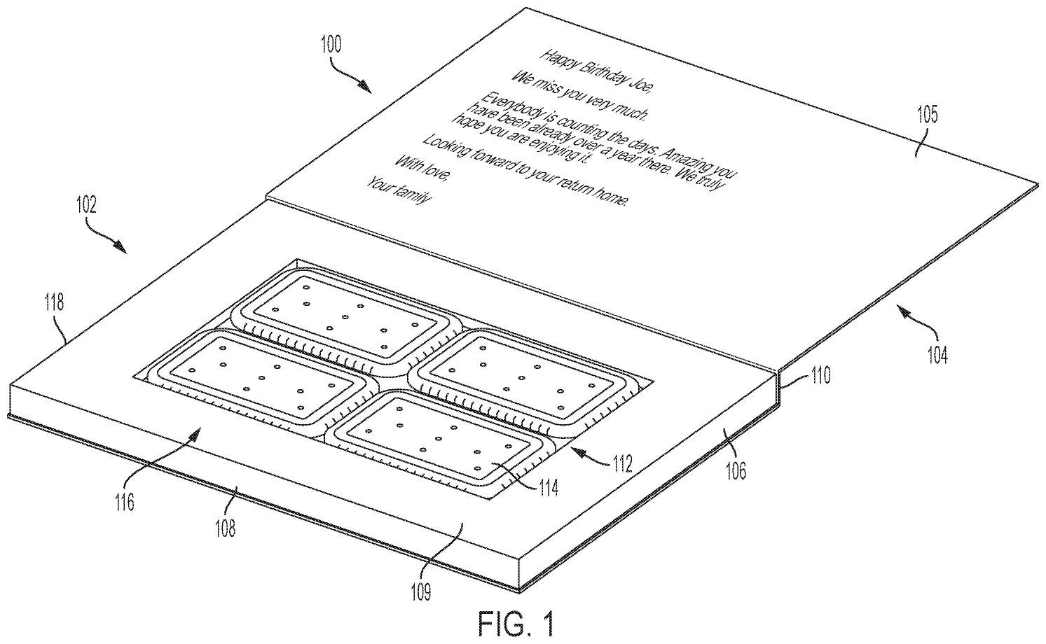

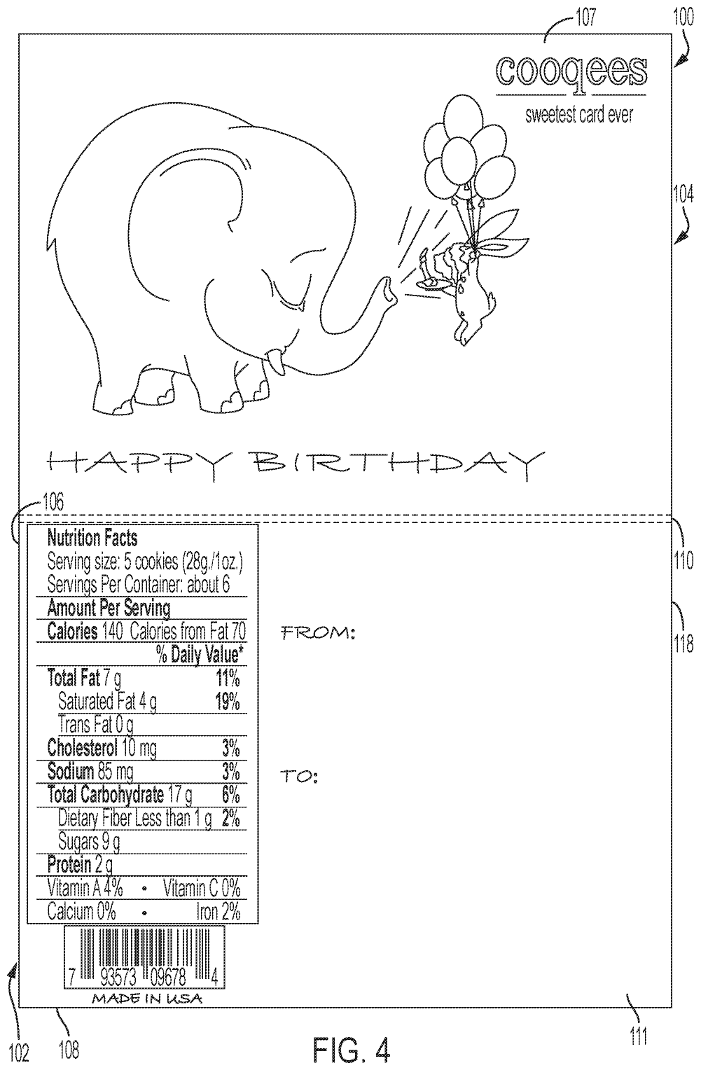

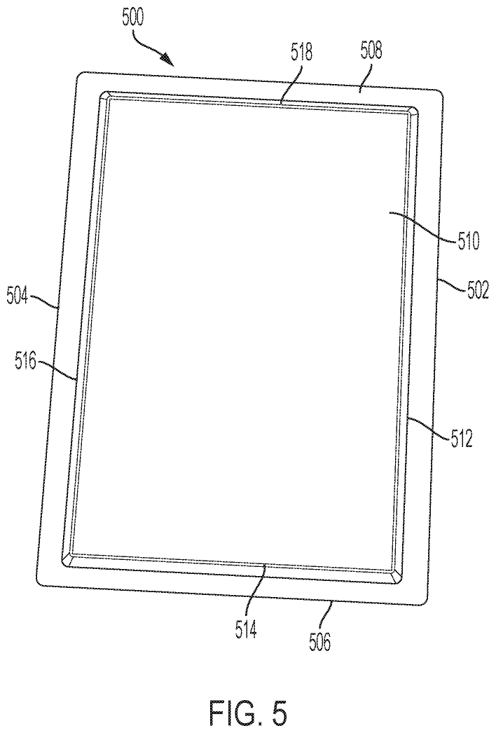

FIG. 1 is a perspective view of a portion of a greeting card system with a gift holder area that is displayed in an open position and constructed in accordance with embodiments of the present invention. Greeting card system 100 includes a top panel 104 coupled to a bottom panel 102 at a spine portion 110, the bottom panel 102 includes a gift holder area 112 configured to receive a gift or treat 114, the bottom panel 102 can include a frame portion 116 that surrounds the gift holder area 112 that includes a left side 118, a right side 106 opposite the left side 118, and a front side 108 opposite the spine portion 110. The bottom panel 102 of the greeting card system 100 has an outer surface 111 (FIG. 4) that can be written on to address the greeting card system 100 to an individual. Similarly, the back surface 107 of the top panel 104 can include artwork or graphics. In addition, the front surface 105 of the top panel 104 can include a sentimental message or the like. In one embodiment, the top panel 104 is pre-perforated at the spine 110 to allow a greeting card recipient to separate this section of the greeting that has a higher emotional value from the bottom panel 102 with the gift holder area 112. In another aspect of the embodiment, the greeting card system 100 can further include a tray 500 (FIG. 5) for insertion into the gift holder area 112 of the greeting card system 100. The tray 500 can include the treat 114 for easy placement in the frame 116 of the bottom panel 102 of the greeting card system 100. In another embodiment, the frame 116 may be removed and a tray 500 may be sized to cover the top surface area 109 of the bottom panel 102 can be used to receive the treat.

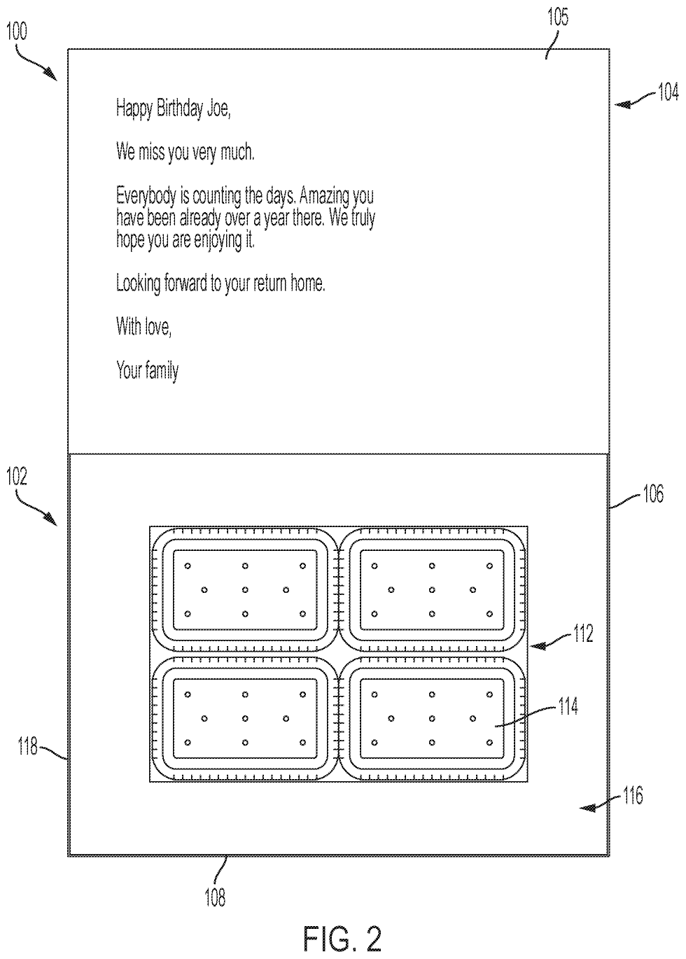

FIG. 2 provides a top view of the greeting card system with a gift holder of FIG. 1 in an open position and assembled in accordance with one embodiment of the present invention. The greeting card system 100 of the example embodiment includes the following components: a top panel 104 coupled to a bottom panel 102 at a spine portion 110, the bottom panel 102 includes a gift holder area 112 configured to receive a gift or treat 114, the bottom panel 102 can include a frame portion 116 that surrounds the gift holder area 112 that includes a left side 107, a right side opposite 106 the left side 118, and a front side 108 opposite the spine portion 110. The bottom panel 102 of the greeting card system 100 has an outer surface 111 (FIG. 4) that can be written on to address the greeting card system 100 to an individual. Similarly, the back surface 107 of the top panel 104 can include artwork or graphics. In addition, the front surface 105 of the top panel 104 can include a sentimental message or the like. In one embodiment, the top panel 104 is attached to the spine 110 in a perforated manner to allow a greeting card recipient to separate this section of the greeting that has a higher emotional value from the bottom panel 102 with the gift holder area 112. In another embodiment, the greeting card system 100 can further include a tray 500 (FIG. 5) for insertion into the gift holder area 112 of the greeting card system 100.

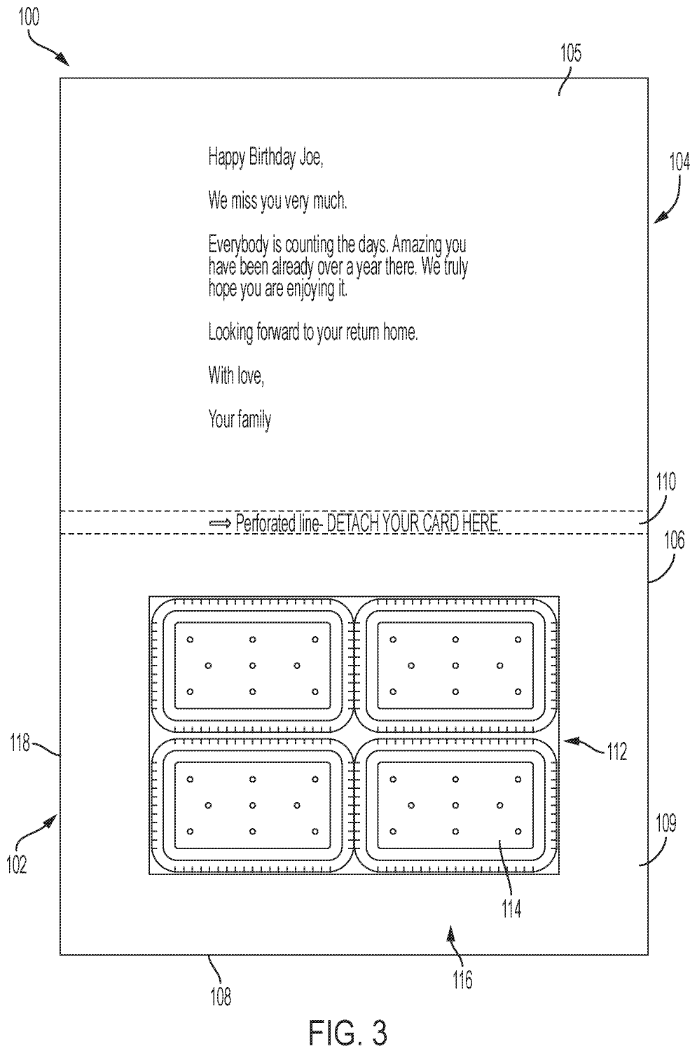

FIG. 3 is a top view of a greeting card with gift holder of FIG. 1 in an open position and assembled in accordance with one embodiment of the present invention. The greeting card system 100 of the example embodiment includes the following components: a top panel 104 coupled to a bottom panel 102 at a spine portion 110, the bottom panel 102 includes a gift holder area 112 configured to receive a gift or treat 114, the bottom panel 102 can include a frame portion 116 that surrounds the gift holder area 112 that includes a left side 118, a right side 106 opposite the left side 118, and a front side 108 opposite the spine portion 110. The bottom panel 102 of the greeting card system 100 has an outer surface 111 (FIG. 4) that can be written on to address the greeting card system 100 to an individual. Similarly, the back surface 107 of the top panel 104 can include artwork or graphics. In addition, the front surface 105 of the top panel 104 can include a sentimental message or the like. As illustrated in FIG. 3, the front surface 105 of top panel 104 includes happy birthday wishes from the recipient's family.

On the back surface 107 of top panel 104, there is illustrated an elephant and bunny rabbit with a bouquet of balloons. In this embodiment, the top panel 104 is pre-perforated at the spine 110 to allow a greeting card recipient to separate this section of the greeting card system 100 that has a higher emotional value from the bottom panel 102 with the gift holder area 112. In another embodiment, the greeting card system 100 can further include a tray 500 (FIG. 5) for insertion into the gift holder area 112 of the greeting card system 100. In one embodiment, the dimensions of the top panel 104 and the bottom panel 102 of greeting card system 100 can be 120 mm by 170 mm wide with a spine 110 of approximately 4 mm. In other embodiments, the dimensions of the top panel 104 and the bottom panel 102 of greeting card system 100 each can be in the range of 80 to 150 mm by 120 to 220 mm wide with a spine 110 of approximately 3 to 5 mm.

FIG. 4 is a rear view of a greeting card with gift holder in an open position and assembled in accordance with one embodiment of the present invention. The greeting card system 100 of the example embodiment includes the following components: a top panel 104 coupled to a bottom panel 102 at a spine portion 110, the bottom panel 102 includes a gift holder area 112 configured to receive a gift or treat 114, the bottom panel 102 can include a frame portion 116 that surrounds the gift holder area 112 that includes a left side 118, a right side 106 opposite the left side 118, and a front side 108 opposite the spine portion 110. The bottom panel 102 of the greeting card system 100 has an outer surface 111 that can be written on to address the greeting card system 100 to an individual. Similarly, the back surface 107 of the top panel 104 can include artwork or graphics. In addition, the front surface 105 of the top panel 104 can include a sentimental message or the like. As illustrated in FIG. 3, the front surface 105 of top panel 104 includes happy birthday wishes from the recipient's family. On the back surface 107 of top panel 104, there is illustrated an elephant and bunny rabbit with a bouquet of balloons. In this embodiment, the top panel 104 is pre-perforated at the spine 110 to allow a greeting card recipient to separate this section of the greeting card system 100 that has a higher emotional value from the bottom panel 102 with the gift holder area 112. In another embodiment, the greeting card system 100 can further include a tray 500 (FIG. 5) for insertion into the gift holder area 112 of the greeting card system 100.

FIG. 5 is a rear perspective view of a tray for insertion into the gift holder of the greeting card of FIG. 3. In embodiments. FIG. 5 illustrates how tray 500 includes bottom panel 510, right edge 502 opposite left edge 504 and bottom edge 506 opposite top edge 508. FIG. 5 further illustrates how tray 500 includes right indent 512 opposite left indent 516 and bottom indent 514 opposite top indent 518. Tray 500 is configured to receive various treats and then be either inserted into the gift holder area 112 of frame 116 or replace frame 116 and be mounted on the bottom panel 102 of greeting card system 100.

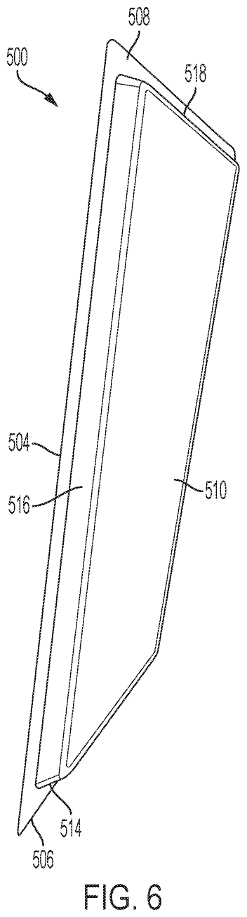

FIG. 6 is a side perspective view of the tray of FIG. 5 of the present invention. FIG. 6 further illustrates how tray 500 includes bottom panel 510, right edge 502 opposite left edge 504 and bottom edge 506 opposite top edge 508. FIG. 6 further illustrates how tray 500 includes right indent 512 opposite left indent 516 and bottom indent 514 opposite top indent 518.

The greeting card system can be provided to a customer via an e-commerce platform or at a retail outlet. For the e-commerce platform, a customer could take the take a series of steps. First, a customer could visit the e-commerce website (e.g. cooqees.com). Second, the customer could select the occasion for which the customer is choosing a particular greeting card. Third, the customer is able to choose the type of edible sweet (e.g., chocolate cookies, vanilla cookies, chocolate bar and the like) that is to be included in the greeting card. Fourth, the customer decides whether to upload a custom photograph, a graphic or drawing. Fifth, the customer may also be able to choose an existing image or graphic from the e-commerce website (e.g. cooqees.com) pre-existing library. Sixth, the customer is prompted to choose from a series of pre-set emotional messages. In another embodiment, the customer is able to type in or specify his or her own message, thereby customizing it for the recipient. Seventh, the customer is presented with the option to add a gift card as part of the greeting card being sent. If the customer chooses yes, then the customer is prompted to enter a value for the greeting card being provided to the recipient. If the customer chooses no, then the customer is directed to the next step in the process. Eighth, the customer can be prompted to enter the sender information, and the recipient information. Ninth, the customer can be presented with a checkout screen for payment.

In another embodiment, the greeting card system can be provided to a customer via retail stores. In this embodiment, a set of pre-printed cards, including assorted edibles are pre-printed then shipped to various retail outlets. The retail outlets are also provided with a display unit which includes the ability to display to prospective consumers a multiplicity of greeting card systems. The greeting card systems and their various messages are then selected by the consumers and purchased at a check-out counter.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention has been described with respect to certain preferred embodiments, but the invention is not limited only to the particular constructions disclosed and shown in the drawings as examples, and also comprises the subject matter and such reasonable modifications or equivalents as are encompassed within the scope of the appended claims.

What is claimed is:

1. A greeting card system comprising:
a greeting card having a top panel connected to a spine of a bottom panel;
a gift holder area defined on the bottom panel;
the top panel including a first surface and a second surface opposite the first surface;
the bottom panel including an inside surface and a back surface opposite the inside surface;
wherein opening the top panel reveals the gift holder area of the bottom panel.

2. The greeting card system of claim 1 further comprising a treat positioned in the gift holder area of the bottom panel.

3. The greeting card system of claim 1, further comprising a tray configured to be positioned in the gift holder area of the bottom panel.

4. The greeting card system of claim 1, further comprising a greeting written on the first surface of the top panel.

5. The greeting card system of claim 1, further comprising artwork on the second surface of the top panel.

6. The greeting card system of claim 1, wherein the top panel is attached to the spine in a perforated manner.

7. A greeting card system comprising:
a greeting card having a top panel connected to a spine of a bottom panel;
a gift holder area defined on the bottom panel;
a frame that surrounds the gift holder area of the bottom panel;
the top panel including a first surface and a second surface opposite the first surface;
the bottom panel including an inside surface and a back surface opposite the inside surface;
wherein opening the top panel reveals the gift holder area of the bottom panel.

8. The greeting card system of claim 7 further comprising a treat positioned in the gift holder area of the bottom panel.

9. The greeting card system of claim 7, further comprising a tray configured to be positioned in the gift holder area of the bottom panel.

10. The greeting card system of claim 7, further comprising a greeting written on the first surface of the top panel.

11. The greeting card system of claim 7, further comprising artwork on the second surface of the top panel.

12. The greeting card system of claim 7, wherein the top panel is attached to the spine in a perforated manner.
